(19) United States
(12) Patent Application Publication
(10) Pub. No.: US 2025/0165872 A1
(43) Pub. Date: May 22, 2025

(54) SELF-CALIBRATING PHASE INTERFEROMETRY USING RANDOM FOREST REGRESSION, NEURAL NETWORK, OR OTHER MACHINE LEARNING MODEL

(71) Applicant: Raytheon Company, Tewksbury, MA (US)

(72) Inventors: Carl A. Nardell, Oro Valley, AZ (US); Brian A. Cronin, Redondo Beach, CA (US)

(21) Appl. No.: 18/512,954

(22) Filed: Nov. 17, 2023

(51) Int. Cl. G06N 20/20; G06N 3/08

(52) U.S. Cl. CPC G06N 20/20; G06N 3/08

(57) ABSTRACT

An apparatus includes multiple antennas each configured to receive one or more incoming signals. The apparatus also includes at least one processing device configured to receive antenna measurements associated with the one or more incoming signals, where the antenna measurements include phase measurements associated with the one or more incoming signals. The at least one processing device is also configured to process the antenna measurements using a trained machine learning model to generate a prediction of an angle of arrival associated with the one or more incoming signals. The trained machine learning model is trained to generate the prediction of the angle of arrival even while compensating for phase errors affecting the antenna measurements.

### TECHNICAL FIELD

This disclosure is generally directed to radio frequency (RF) interferometers. More specifically, this disclosure is directed to self-calibrating phase interferometry using random forest regression, a neural network, or other machine learning model.

### BACKGROUND

Interferometers are used in numerous fields to obtain useful information. In some cases, for instance, interferometers may be used to identify the angles of arrival of incoming radio frequency (RF) signals. Among other things, this supports direction finding, meaning the directions of signal sources with respect to a reference position can be determined. This may be useful in various commercial and defense-related applications. For example, an angle of arrival of an incoming signal can be used to identify the direction of an airplane, ground vehicle, naval vessel, or other signal source on the ground, in the air, on the water, or in space from a reference position. This capability can also lend itself to other functions, such as identifying pulse-to-pulse correlations to support pulse deinterleaving or determining to what extent an aircraft or other object's cross-section might be visible to the source of the incoming signals.

### SUMMARY

This disclosure relates to self-calibrating phase interferometry using random forest regression, a neural network, or other machine learning model.

In a first embodiment, an apparatus includes multiple antennas each configured to receive one or more incoming signals. The apparatus also includes at least one processing device configured to receive antenna measurements associated with the one or more incoming signals, where the antenna measurements include phase measurements associated with the one or more incoming signals. The at least one processing device is also configured to process the antenna measurements using a trained machine learning model to generate a prediction of an angle of arrival associated with the one or more incoming signals. The trained machine learning model is trained to generate the prediction of the angle of arrival even while compensating for phase errors affecting the antenna measurements.

In a second embodiment, a method includes receiving one or more incoming signals at multiple antennas and providing antenna measurements associated with the one or more incoming signals to a trained machine learning model, where the antenna measurements include phase measurements associated with the one or more incoming signals. The method also includes processing the antenna measurements using the trained machine learning model to generate a prediction of an angle of arrival associated with the one or more incoming signals. The trained machine learning model is trained to generate the prediction of the angle of arrival even while compensating for phase errors affecting the antenna measurements.

In a third embodiment, a non-transitory machine-readable medium contains instructions that when executed cause at least one processor to obtain antenna measurements associated with one or more incoming signals received at multiple antennas, where the antenna measurements include phase measurements associated with the one or more incoming signals. The non-transitory machine-readable medium also contains instructions that when executed cause the at least one processor to provide the antenna measurements to a trained machine learning model and process the antenna measurements using the trained machine learning model to generate a prediction of an angle of arrival associated with the one or more incoming signals. The trained machine learning model is trained to generate the prediction of the angle of arrival even while compensating for phase errors affecting the antenna measurements.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example interferometer supporting self-calibrating phase interferometry using random forest regression, a neural network, or other machine learning model according to this disclosure;

FIG. 2 illustrates an example device supporting self-calibrating phase interferometry using random forest regression, a neural network, or other machine learning model in the interferometer of FIG. 1 according to this disclosure;

FIGS. 3A and 3B illustrate example machine learning models supporting self-calibrating phase interferometry in the interferometer of FIG. 1 according to this disclosure;

FIGS. 4 through 6 illustrate an example use case for applying self-calibrating phase interferometry using random forest regression, a neural network, or other machine learning model according to this disclosure; and

FIG. 7 illustrates an example method for self-calibrating phase interferometry using random forest regression, a neural network, or other machine learning model according to this disclosure.

### DETAILED DESCRIPTION

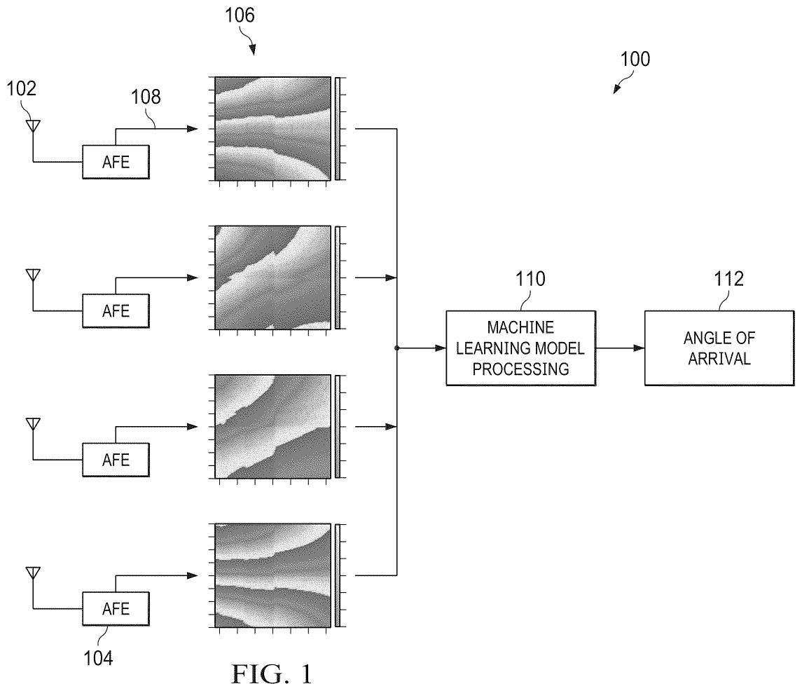

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, interferometers are used in numerous fields to obtain useful information. In some cases, for instance, interferometers may be used to identify the angles of arrival of incoming radio frequency (RF) signals. Among other things, this supports direction finding, meaning the directions of signal sources with respect to a reference position can be determined. This may be useful in various commercial and defense-related applications. For example, an angle of arrival of an incoming signal can be used to identify the direction of an airplane, ground vehicle, naval vessel, or other signal source on the ground, in the air, on the water, or in space from a reference position. This capability can also lend itself to other functions, such as identifying pulse-to-pulse correlations to support pulse deinterleaving or determining to what extent an aircraft or other object's cross-section might be visible to the source of the incoming signals.

When systems are used to perform phase measurements to support precision direction finding via interferometry, various manufacturing and bias calibration requirements are typically placed upon the systems. For example, precision phase measurement systems often need signal cables from antennas to be manufactured to precise lengths, and phase bias calibration capabilities are often built into these systems in order to account for variables such as manufacturing tolerances, thermal effects, and ageing effects. Moreover, compensations for remaining issues that can affect precision phase measurement systems often use additional circuitry. These approaches can therefore increase the size, weight, power, and cost (SWaP-C) of the precision phase measurement systems, increase the complexity of the precision phase measurement systems, and reduce the reliability of the precision phase measurement systems due to the existence of additional failure points within the systems. In addition, even with these approaches, relatively large errors may still exist in phase measurements captured using these systems.

This disclosure provides various techniques for self-calibrating phase interferometry using random forest regression, a neural network, or other machine learning model. As described in more detail below, an interferometer includes multiple antennas. Each antenna has an associated antenna response, which defines how phases (and possibly amplitudes) of electrical signals generated by the antenna can vary based on an angle of arrival of one or more incoming signals. The electrical signals generated by each antenna can be used to generate phase measurements and optionally amplitude measurements, such as in the form of complex voltages. At least the phase measurements generated using the antennas are processed (possibly after pre-processing) using a random forest regressor, neural network, or other machine learning model. The machine learning model is trained to account for and handle phase errors in the phase measurements or other measurements, which may be caused by unequal cabling or other factors. As a result, the machine learning model is able to process the measurements and generate a prediction of the angle of arrival of the one or more incoming signals. The angle of arrival may be used for any suitable purpose, such as direction finding.

In this way, it is possible to more quickly and easily identify the angles of arrival of incoming signals while handling phase errors that exist in a system, including phase errors caused by physical factors (like unequal cabling), drift, or bias. This can be accomplished by training the random forest regressor, neural network, or other machine learning model to effectively learn what phase errors look like in terms of input data being processed by the machine learning model. As a result, precision phase measurement systems can be calibrated algorithmically, which can help to reduce the SWaP-C of the precision phase measurement systems, improve the reliability of the precision phase measurement systems, and/or improve the performance of the precision phase measurement systems. In some cases, this may reduce or even eliminate the need for on-board calibration capabilities or specialized calibration circuitry in the precision phase measurement systems.

Note that the techniques described in this patent document may find use in various applications. For example, in the discussion below, it is often assumed that the techniques described in this patent document are used with an aircraft in order to identify the angles of arrival of incoming signals received at the aircraft. However, this use case is for illustration and explanation only. The techniques described in this patent document may be used in any other suitable manner. For instance, devices and systems that support 5G communications or use global navigation satellite system (GNSS) signals (such as global positioning system or GPS receivers) may use the described techniques to perform direction finding. As particular example use cases, the described techniques may be used to support digital beamforming, communications, signal intelligence, or electronic intelligence. In general, the techniques described in this disclosure may be used for determining angles of arrival by any suitable device(s) and in any suitable system(s), and the angles of arrival may be used for any suitable purpose(s).

FIG. 1 illustrates an example interferometer 100 supporting self-calibrating phase interferometry using random forest regression, a neural network, or other machine learning model according to this disclosure. As shown in FIG. 1, the interferometer 100 includes multiple antennas 102, where each antenna 102 is configured to receive one or more incoming signals. For example, each antenna 102 may be configured to receive one or more incoming RF signals or other incoming signals at any suitable frequency or frequencies. Each antenna 102 includes any suitable structure configured to receive incoming electromagnetic signals. In some embodiments, for instance, the antennas 102 may represent dipole antennas, spiral antennas, or other suitable antennas. As a particular example, the antennas 102 may be formed using an antenna array, where different antennas 102 are associated with different array sub-apertures. In this example, the interferometer 100 is shown as including four antennas 102, but the interferometer 100 may include two or more antennas 102 depending on the implementation. In some cases, such as for phased array antennas, the number of antennas 102 may be quite large.

Electrical signals generated by the antennas 102 based on one or more incoming signals are provided to respective analog front ends (AFEs) 104, each of which is configured to process the electrical signals and generate antenna measurements associated with the one or more incoming signals. For example, each analog front end 104 can perform sampling in order to generate samples of the electrical signals for further processing. In some embodiments, each analog front end 104 may generate complex voltages that represent the one or more incoming signals as in-phase (I) or real voltages and quadrature (Q) or imaginary voltages, where the real voltage of a complex voltage can be defined as real voltage=amplitude*cos(phase) and the imaginary voltage of a complex voltage can be defined as amplitude*sin(phase). In some cases, each analog front end 104 may include a direct digital sampler or a sampler that processes a down-converted signal, although any other suitable sampling mechanism may be used here.

Each analog front end 104 can also perform correlations in order to associate pulses within the one or more incoming signals with one another. For example, each analog front end 104 may convert the complex voltages into pulse descriptor words, which can assign attributes like amplitude, phase, and time of arrival to individual pulses in the one or more incoming signals. Since the same incoming signal can be received by multiple antennas 102 (shifted in time and phase and differing somewhat in amplitude from one another), the correlations here help to associate different pulses with the same signal source(s). This is often referred to as pulse deinterleaving. Once the pulses are associated with each other, each analog front end 104 can convert the amplitudes and phases of the pulses back into complex voltages. Note that using phase by itself may suffer from issues since the phase wraps every 360°, which can create numerical problems for subsequent processing, but using complex data can help to reduce or eliminate this issue.

Each antenna 102 is associated with an antenna response 106, which defines how the phases and amplitudes of the complex voltages representing the one or more received signals can vary based on angles of arrival of incoming signals. In other words, the complex voltages that are generated by each analog front end 104 can represent phase measurements and amplitude measurements that vary in accordance with the antenna response 106 of the associated antenna 102. For instance, each antenna response 106 may identify how the phase and amplitude associated with an incoming signal can vary depending on the azimuth and elevation of the (apparent) source of the incoming signal. If needed or desired, the phase and amplitude measurements (such as in the form of complex voltages) may undergo suitable pre-processing prior to further use, such as to filter the phase and amplitude measurements.

The antennas 102 and/or analog front ends 104 in this example provide electrical signals over associated signal cables 108. Each signal cable 108 represents any suitable electrically-conductive medium through which electrical signals can be transported. Each signal cable 108 may be formed using any suitable material(s), such as an electrically-conductive material like copper or other metal(s) within an insulative sheath or other covering. As shown in FIG. 1, it is possible for the signal cables 108 to have different lengths. The differences in lengths shown in FIG. 1 are exaggerated for ease of illustration. Unlike prior systems that might require strict length matching of signal cables, the techniques described in this patent document are able to compensate for phase errors caused by (among other things) signal cables 108 that have different lengths. Note, however, that the signal cables 108 may alternatively have substantially the same lengths. In those cases, the described techniques may still be used to compensate for phase errors caused by other factors.

The antenna measurements represented by the complex voltages are provided to a machine learning model processing function 110, which analyzes at least some of the measurements in order to estimate an angle of arrival 112 of the one or more incoming signals based on the analyzed measurements. As described below, the machine learning model processing function 110 uses a machine learning model that has been trained to account for phase errors associated with the measurements being analyzed when generating predictions of the angle of arrival 112 of the one or more incoming signals. Effectively, the machine learning model processing function 110 can be trained to implement one or more functional mappings between (i) antenna phase measurements or other measurements and (ii) angles of arrival 112, which may be expressed in any suitable manner (such as azimuth and elevation angles).

In some embodiments, the interferometer 100 may include n antennas 102 that generate at least phase measurements varying based on n antenna responses 106. In particular embodiments, n has a value of at least four, although lower values may be possible. This might ordinarily require up to n different circuits for providing compensation for unequal cabling, drift, bias, or other issues that might create phase errors in phase measurements. In the interferometer 100, the machine learning model processing function 110 can be trained to handle phase errors in phase measurements, which allows the machine learning model processing function 110 to be used to effectively identify angles of arrival 112. Additional details of the machine learning model processing function 110 are provided below.

Although FIG. 1 illustrates one example of an interferometer 100 supporting self-calibrating phase interferometry using random forest regression, a neural network, or other machine learning model, various changes may be made to FIG. 1. For example, the interferometer 100 may include any suitable number of antennas 102 and any suitable number of associated antenna responses 106. In this example, there are four antennas 102 and four associated antenna responses 106, although this is for illustration and explanation only. Also, the antennas 102 may have any desired arrangement and need not be positioned or spaced to satisfy strict requirements. In some cases, the described approaches can support arbitrary antenna placements, which can greatly simplify installation and use. In addition, the signal cables 108 may or may not have lengths that precisely match.

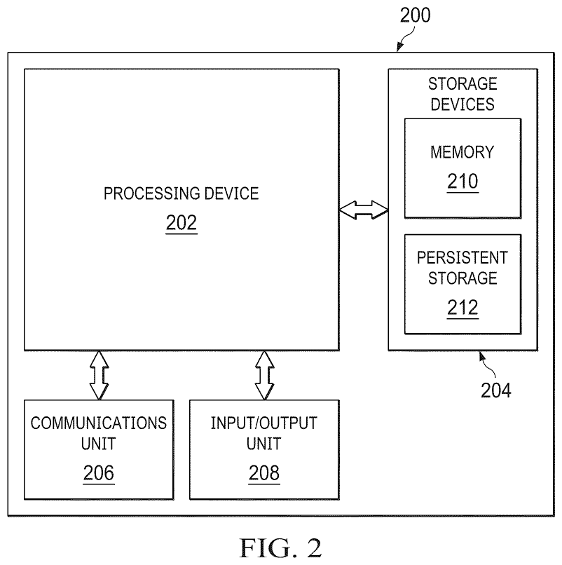

FIG. 2 illustrates an example device 200 supporting self-calibrating phase interferometry using random forest regression, a neural network, or other machine learning model in the interferometer 100 of FIG. 1 according to this disclosure. More specifically, FIG. 2 illustrates an example device 200 that may form part of or be used in conjunction with the interferometer 100. The device 200 here may be used to implement the machine learning model processing function 110 of the interferometer 100.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication of estimated angles of arrival 112 to one or more external destinations for use. Note, however, that the processing device 202 itself may also or alternatively use the estimated angles of arrival 112, and the estimated angles of arrival 112 may or may not be communicated outside the device 200.

The I/O unit 208 allows for input and output of data. For example, the I/O unit 208 may be used to receive phase measurements, amplitude measurements, or other data from the antennas 102. The I/O unit 208 may also be used for other interactions. For instance, the I/O unit 208 may provide a connection for user input through a keyboard, mouse, keypad, touchscreen, or other suitable input device. The I/O unit 208 may also send output to a display or other suitable output device. Note, however, that these functions may be optional, such as when the device 200 or the interferometer 100 does not require local I/O (like when the device 200 or the interferometer 100 can be accessed remotely).

In some embodiments, the instructions executed by the processing device 202 include instructions that implement the machine learning model processing function 110. Thus, for example, the instructions when executed by the processing device 202 may cause the device 200 to obtain phase measurements and amplitude measurements, such as in the form of complex voltages (which may be pre-processed if needed or desired). The instructions when executed by the processing device 202 may also cause the device 200 to process the measurements using a machine learning model and generate angles of arrival 112 and phase error estimates. The instructions when executed by the processing device 202 may optionally cause the device 200 to use the angles of arrival 112 and/or phase error estimates to perform one or more functions, such as for direction finding or other purposes.

Although FIG. 2 illustrates one example of a device 200 supporting self-calibrating phase interferometry using random forest regression, a neural network, or other machine learning model in the interferometer 100 of FIG. 1, various changes may be made to FIG. 2. For example, computing and communication devices and systems come in a wide variety of configurations, and FIG. 2 does not limit this disclosure to any particular computing or communication device or system. The machine learning model processing function 110 of the interferometer 100 may be implemented in any other suitable manner. For instance, data collected by or using the antennas 102 and the analog front ends 104 may be post-processed offline or uploaded over a data link, such as to a cloud computing resource or other computing system. It is also possible for the logic of the machine learning model processing function 110 to be hosted in a containerized environment, in which case at least some of the hardware shown in FIG. 2 may be virtualized.

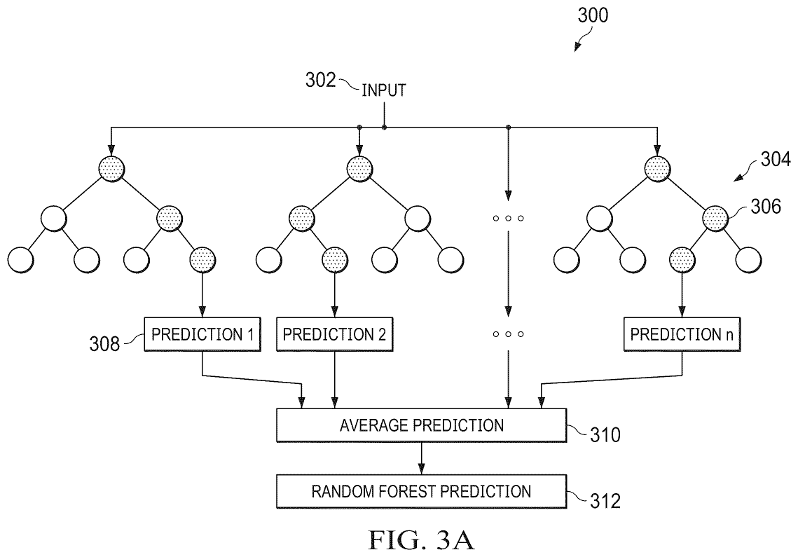

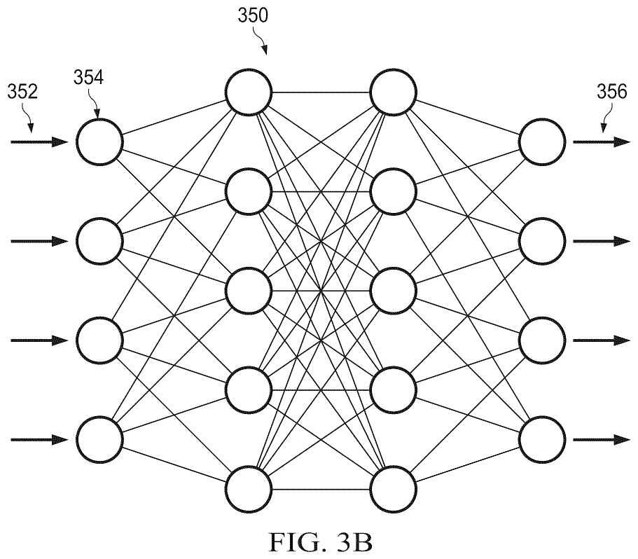

FIGS. 3A and 3B illustrate example machine learning models 300, 350 supporting self-calibrating phase interferometry in the interferometer 100 of FIG. 1 according to this disclosure. As shown in FIG. 3A, the machine learning model processing function 110 in this example may be implemented using a machine learning model 300 designed as a random forest regressor. Here, the machine learning model 300 is configured to receive and process input data 302, which in this example may include phase measurements and optionally amplitude measurements and which can be associated with or based on the antenna responses 106. The machine learning model 300 implements multiple decision trees 304, where each decision tree 304 includes a number of nodes 306 logically positioned in multiple layers or levels of the decision tree 304.

Each node 306 in a layer of a decision tree 304 can process at least some of the input data 302 and make determinations as to which node 306 in an adjacent lower layer of the decision tree 304 will be used to process the input data 302, except for the leaf nodes 306 (the bottom nodes 306 in the decision tree 304). When specific input data 302 is being processed by each decision tree 304, the input data 302 is processed using the sole node 306 in the top layer of that decision tree 304. This node 306 analyzes the input data 302 and selects one node 306 in the second layer of the decision tree 304 that will receive and process the input data 302. That node 306 analyzes the input data 302 and selects one node 306 in the third layer of the decision tree 304 that will receive and process the input data 302. This process may continue through the layers of the decision tree 304 until one of the leaf nodes 306 at the lowest layer of the decision tree 304 is reached. Note that each node 306 may process the same portion(s) of the input data 302 or different portions of the input data 302. The leaf node 306 generates an initial prediction 308 based on the input data 302. In the specific context here, each initial prediction 308 can represent an initial prediction of an angle of arrival 112 based on the antenna measurements being processed. Each initial prediction 308 can also include an estimate of phase errors affecting the measurements being processed.

A combination function 310 combines the initial predictions 308 in order to generate a random forest prediction 312, which represents or includes a final prediction of the angle of arrival 112 based on the measurements being processed. The random forest prediction 312 may also include a final prediction of phase errors affecting the measurements being processed. The combination function 310 may use any suitable technique to combine the initial predictions 308 and generate the random forest prediction 312. In the illustrated example, the combination function 310 performs an averaging function, which can average the initial predictions 308. However, the combination function 310 may perform other calculations to generate the random forest prediction 312. Other example implementations of the combination function 310 may include majority voting (where the most common initial prediction 308 is used as the random forest prediction 312) or weighted averaging (where confidence levels or other values associated with the initial predictions 308 are used to weight the initial predictions 308 during the averaging).

Each decision tree 304 here represents a decision tree regressor or estimator used to predict an angle of arrival 112. One or more hyperparameters may be used to help define the structure or operation of each decision tree 304, such as when hyperparameters are used to define the minimum number of input samples at each leaf node 306 needed to make an initial prediction 308 or the maximum depth (number of layers of nodes 306) that each decision tree 304 may include.

The machine learning model 300 can be trained in any suitable manner to generate angles of arrival 112 and phase error estimates. During training, the machine learning model 300 can be modified so that the nodes 306 of the decision trees 304 process training data and collectively arrive at accurate estimates of the angles of arrival 112 and phase errors affecting the measurements being processed, at least to within some threshold level of accuracy. Among other things, this may involve adjusting the determinations made by the individual nodes 306 in each decision tree 304, adjusting the number of nodes 306 in each decision tree 304, and adjusting the number of layers in each decision tree 304. Moreover, the training data used here can include phase errors to train the machine learning model 300 to recognize such phase errors during operation. For instance, random phase errors ranging in value from −180° to +180° (meaning from −π to +π) or from −360° to +360° (meaning from −2π to +2π) may be introduced into the training data during the training process.

In some embodiments, the machine learning model 300 may undergo a training process in which training data takes the form of phase measurements and optionally other measurements (such as amplitude measurements) that are provided to the machine learning model 300, which generates random forest predictions 312 identifying estimated angles of arrival 112 and phase errors included in the training data. The random forest predictions 312 can be compared to known ground truths, which represent correct angles of arrival 112 and correct phase errors that the machine learning model 300 should have generated based on the training data. When errors or differences between the angles of arrival 112 and phase errors generated by the machine learning model 300 and the ground truths exceed a threshold, the decision trees 304 of the machine learning model 300 can be adjusted in various ways, such as those noted above. Once adjusted, another round of training may occur in which the same or different training data is provided to the adjusted decision trees 304 of the machine learning model 300, and additional angles of arrival 112 and phase errors are generated and compared to their ground truths so that additional errors can be calculated and compared to the threshold. This process may continue until (ideally) the machine learning model 300 generates adequately-accurate angles of arrival 112 and phase errors. At this point, the machine learning model 300 may be used to provide mappings between (i) phase measurements actually generated by the antennas 102 and (ii) angles of arrival 112 and phase error estimates. In particular embodiments, the phase measurements can take the form of voltages, and the machine learning model 300 can be trained and used to directly map those voltages into angles of arrival 112 and phase error estimates.

Note that during this training process, the training data can be modified by introducing random phase errors into the phase measurements and optionally other measurements of the training data. The angles of arrival defined by the ground truths may remain unchanged, while the phase errors defined by the ground truths can be updated to reflect the random phase errors. This helps train the machine learning model 300 to produce accurate angles of arrival 112 even in the presence of phase errors, and this allows the machine learning model 300 to learn how to produce accurate estimates of the phase errors. This is because the effects of the phase errors are included in and represented by the training data used to train the machine learning model 300.

Through suitable training of the machine learning model 300, the machine learning model processing function 110 can be trained to effectively identify angles of arrival 112 for incoming signals and identify phase errors affecting phase measurements or other measurements associated with those incoming signals. The machine learning model 300 can be effective even in the presence of noise, such as when poor signal-to-noise ratios are present or there is random phase noise in the antenna measurements being processed. The accuracy of the machine learning model 300 can be based, at least in part, on the number of decision trees 304 used in the machine learning model 300.

As shown in FIG. 3B, the machine learning model processing function 110 in this example may be implemented using a machine learning model 350 designed as a neural network. Here, the machine learning model 350 is configured to receive and process input data 352, which in this example may include phase measurements and optionally amplitude measurements and which can be associated with or based on the antenna responses 106. The machine learning model 350 includes multiple neurons 354 that collectively process the input data 352 and generate outputs 356, which can include estimated angles of arrival 112 and phase errors affecting the measurements being processed. The neurons 354 are arranged in layers, where the left-most layer in this example represents an input layer and the right-most layer in this example represents an output layer. One or more additional layers of neurons 354 between the input and output layers generally represent hidden layers.

The machine learning model 350 can be trained in any suitable manner to generate angles of arrival 112 and phase error estimates. During training, the machine learning model 350 can be modified so that the neurons 354 process training data and collectively arrive at accurate estimates of the angles of arrival 112 and phase errors affecting the measurements being processed, at least to within some threshold level of accuracy. Among other things, this may involve adjusting the weights or other parameters of the individual neurons 354, adjusting the number of neurons 354, and adjusting the number of layers of neurons 354. Moreover, the training data used here can include phase errors to train the machine learning model 350 to recognize such phase errors during operation. For instance, random phase errors ranging in value from −180° to +180° (meaning from −π to +π) or from −360° to +360° (meaning from −2π to +2π) may be introduced into the training data during the training process.

In some embodiments, the machine learning model 350 may undergo a training process in which training data takes the form of phase measurements and optionally other measurements (such as amplitude measurements) that are provided to the machine learning model 350, which generates outputs 356 identifying estimated angles of arrival 112 and phase errors included in the training data. The outputs 356 can be compared to known ground truths, which represent correct angles of arrival 112 and correct phase errors that the machine learning model 350 should have generated based on the training data. When errors or differences between the angles of arrival 112 and phase errors generated by the machine learning model 350 and the ground truths exceed a threshold, various neurons 354 of the machine learning model 350 can be adjusted in various ways, such as those noted above. Once adjusted, another round of training may occur in which the same or different training data is provided to the adjusted machine learning model 350, and additional angles of arrival 112 and phase errors are generated and compared to their ground truths so that additional errors can be calculated and compared to the threshold. This process may continue until (ideally) the machine learning model 350 generates adequately-accurate angles of arrival 112 and phase errors. At this point, the machine learning model 350 may be used to provide mappings between (i) phase measurements actually generated by the antennas 102 and (ii) angles of arrival 112 and phase error estimates. In particular embodiments, the phase measurements can take the form of voltages, and the machine learning model 350 can be trained and used to directly map those voltages into angles of arrival 112 and phase error estimates.

Note that during this training process, the training data can be modified by introducing random phase errors into the phase measurements and optionally other measurements of the training data. The angles of arrival defined by the ground truths may remain unchanged, while the phase errors defined by the ground truths can be updated to reflect the random phase errors. This helps train the machine learning model 350 to produce accurate angles of arrival 112 even in the presence of phase errors, and this allows the machine learning model 350 to learn how to produce accurate estimates of the phase errors. This is because the effects of the phase errors are included in and represented by the training data used to train the machine learning model 350.

Although FIGS. 3A and 3B illustrate examples of machine learning models 300, 350 supporting self-calibrating phase interferometry in the interferometer 100 of FIG. 1, various changes may be made to FIGS. 3A and 3B. For example, the machine learning model 300 may include any suitable number of decision trees 304, each decision tree 304 may include any suitable number of nodes 306, and the nodes 306 of each decision tree 304 may be arranged in any suitable number of layers. Also, the machine learning model 350 may include any suitable number of neurons 354 and layers of neurons 354. In some cases, the design of the machine learning model 300 or 350 may be limited by available resources, such as processing or memory resources. In addition, while FIGS. 3A and 3B illustrate two examples of machine learning models 300, 350 supporting self-calibrating phase interferometry, machine learning models having other architectures may be used here.

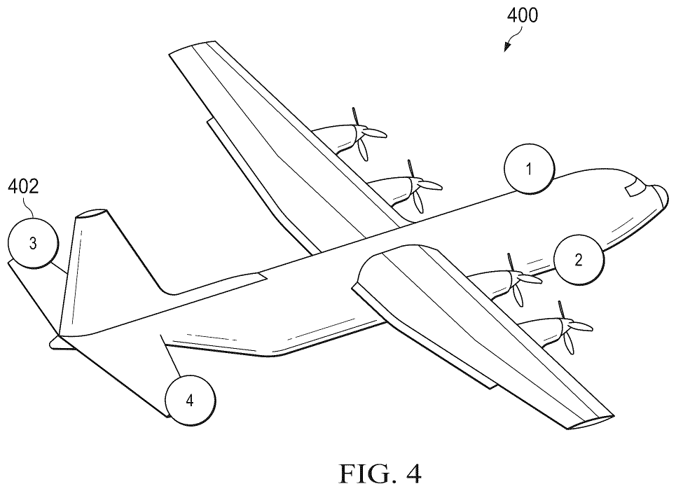

FIGS. 4 through 6 illustrate an example use case for applying self-calibrating phase interferometry using random forest regression, a neural network, or other machine learning model according to this disclosure. As shown in FIG. 4, one example of a system 400 in which an interferometer 100 may be used represents an aircraft. Various positions 402 on the aircraft identified in FIG. 4 represent locations where the antennas 102 may be positioned. Note that the number of positions 402 and the locations of the positions 402 on the aircraft can vary as needed or desired. In this particular example, the positions 402 include two positions (labeled “1” and “2”) near the nose of the aircraft that are positioned on opposite sides of a longitudinal axis of the aircraft, as well as two positions (labeled “3” and “4”) on the tail of the aircraft that are positioned on opposite sides of the longitudinal axis of the aircraft. However, these positions 402 are for illustration and explanation only.

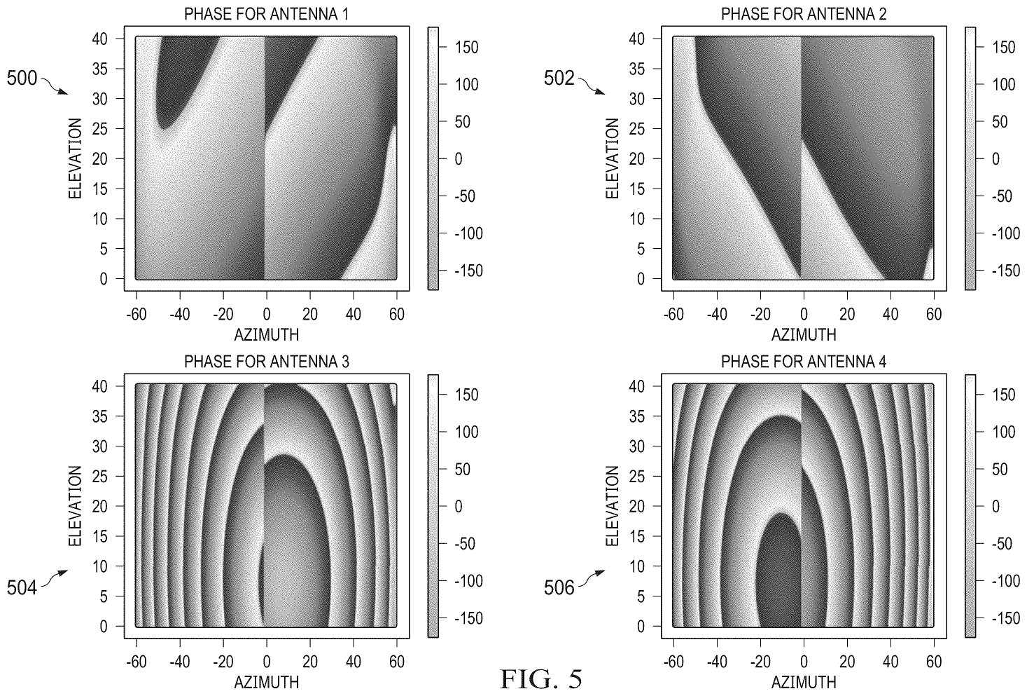

Example phase responses for the antennas 102 in these positions 402 are shown in various charts 500-506 in FIG. 5. More specifically, the charts 500-506 illustrate phase responses of the antennas 102 relative to a phase center associated with a midpoint or center of the aircraft for a 1 GHz incoming signal. The phase response of each antenna 102 varies here based on the angle of arrival for the incoming signal, where each chart 500-506 identifies the phase response of the associated antenna 102 as a function of azimuth (along the horizontal axis) and elevation (along the vertical axis).

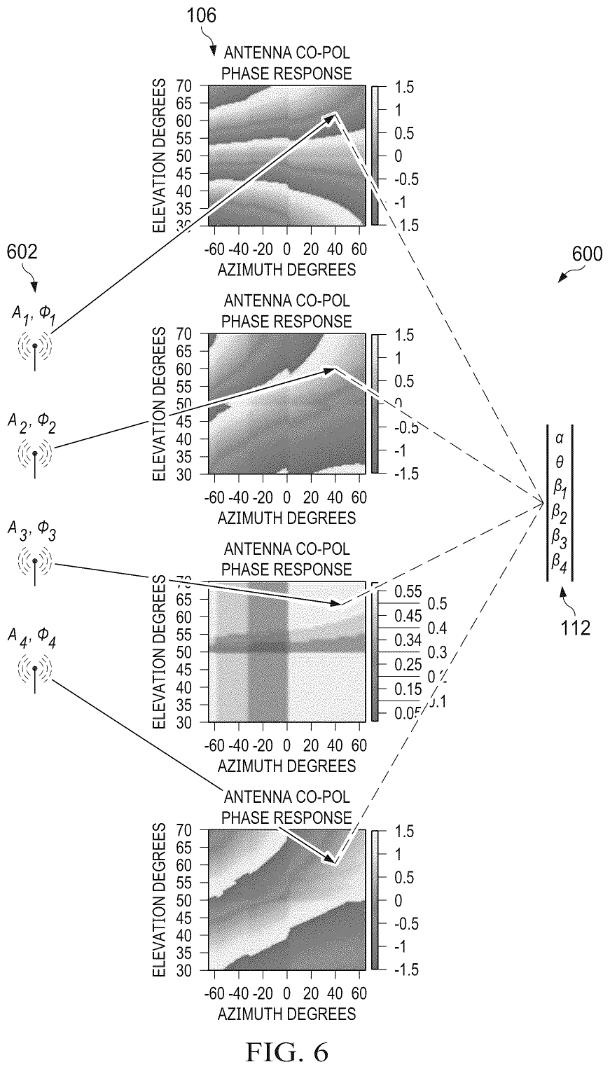

A process 600 as shown in FIG. 6 can be used to analyze antenna measurements and identify angles of arrival 112 and phase errors. In this process 600, input data 602 includes amplitude measurements (denoted A₁-A₄) and phase measurements (denoted ϕ₁-ϕ₄) obtained using a number of antennas 102. The input data 602 may, for example, represent the input data 302 or 352 described above with respect to FIGS. 3A and 3B. These amplitude and phase measurements are based on the antenna responses 106 of the antennas 102, meaning the amplitude and phase measurements are associated with at least one incoming signal and vary based on the angle of arrival of the incoming signal(s). These amplitude and phase measurements are also potentially subject to various phase errors, such as phase errors caused by unequal signal cable lengths, thermal effects, or degradation due to ageing. The amplitude and phase measurements are provided to the machine learning model processing function 110, which processes the measurements in order to generate a final estimate of the angle of arrival 112 of the incoming signal(s). The final estimate of the angle of arrival 112 is defined here using two angles, namely α (for azimuth) and θ (for elevation). The machine learning model processing function 110 also generates estimates of phase errors β₁-β₄ that affect the measurements from the four antennas 102 here. Note that the outputs of the machine learning model processing function 110 here can be generated for different pulses contained in the same incoming signal(s). For example, values for α, θ, and β1-γ₄ here can be generated for each pulse or each subset of pulses contained in the same incoming signal(s).

Although FIGS. 4 through 6 illustrate one example use case for applying self-calibrating phase interferometry using random forest regression, a neural network, or other machine learning model, various changes may be made to FIGS. 4 through 6. For example, the interferometer 100 may be used on any other suitable platform or in any other suitable device or system. Also, the phase responses shown in FIG. 5 and the antenna responses shown in FIG. 6 are for illustration and explanation only and can easily vary depending on the installation and design of the antennas 102 being employed. Further, while the machine learning model is shown here as generating outputs that include phase errors β₁-β₄, the machine learning model may generate only an angle of arrival 112 while compensating for (but not outputting) the phase errors β₁-β₄. In addition, the number of antennas 102 used and the number of phase errors β₁-β₄ generated can vary depending on the implementation.

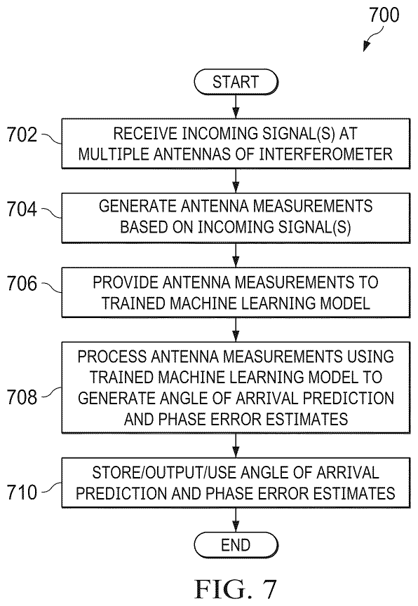

FIG. 7 illustrates an example method 700 for self-calibrating phase interferometry using random forest regression, a neural network, or other machine learning model according to this disclosure. For ease of explanation, the method 700 is described as being performed using the interferometer 100 of FIG. 1, which may include or be used in conjunction with the device 200 of FIG. 2. However, the method 700 may be used with any suitable device(s) and in any suitable system(s).

As shown in FIG. 7, one or more incoming signals are received at multiple antennas of an interferometer at step 702. This may include, for example, receiving one or more incoming signals from a signal source at multiple antennas 102 of the interferometer 100, such as from an airplane, ground vehicle, naval vessel, or other signal source on the ground, in the air, on the water, or in space. Antenna measurements based on the one or more incoming signals are generated at step 704. This may include, for example, sampling electrical signals from the antennas 102 in order to generate complex voltages, correlating related pulses from one or more common signal sources, and converting pulse descriptor words back into complex voltages. The complex voltages can include or represent phase measurements and amplitude measurements associated with the one or more incoming signals. In some cases, the antenna measurements may undergo pre-processing, such as to filter the antenna measurements.

The antenna measurements are provided to a trained machine learning model at step 706, and the antenna measurements are processed using the trained machine learning model to generate an angle of arrival prediction and phase error estimates at step 708. This may include, for example, the machine learning model 300 using the decision trees 304 to process at least some of the phase measurements (and optionally at least some of the amplitude measurements) in order to generate initial predictions 308 of an angle of arrival of the one or more incoming signals and phase errors and combining the initial predictions 308 to produce a random forest prediction 312. This may alternatively include the machine learning model 350 using the neurons 354 to process at least some of the phase measurements (and optionally at least some of the amplitude measurements) in order to generate outputs 356, which include an estimated angle of arrival 112 and phase errors. Other types of machine learning model architectures may be used here to generate the angle of arrival prediction and the phase error estimates.

The angle of arrival prediction and the phase error estimates are stored, output, or used in some manner at step 710. This may include, for example, the interferometer 100 or an external component using the angle of arrival and/or the phase error estimates to perform direction finding in order to identify an estimated direction to the source of the incoming signal(s). The exact use of the angle of arrival and/or the phase error estimates can vary depending on the application or use case. For instance, phase errors generated using the interferometer 100 may be provided to a Kalman filter or other tracking algorithm. Also, since phrase errors (particularly bias errors) may not change very quickly, this information may be used to remove the phase errors for use by other sensors.

Although FIG. 7 illustrates one example of a method 700 for self-calibrating phase interferometry using random forest regression, a neural network, or other machine learning model, various changes may be made to FIG. 7. For example, while shown as a series of steps, various steps in FIG. 7 may overlap, occur in parallel, occur in a different order, or occur any number of times. As a particular example, the various steps of the method 700 can be repeatedly performed in order to identify the angles of arrival of the same incoming signal(s) or different incoming signals over time. Because of the features of some embodiments of the interferometer 100 described above, the angles of arrival and the phase error estimates may be determined in real-time in some cases.

It should be noted that the functions shown in or described with respect to FIGS. 1 through 7 can be implemented in an interferometer or other device(s) in any suitable manner. For example, in some embodiments, at least some of the functions shown in or described with respect to FIGS. 1 through 7 can be implemented or supported using software instructions that are executed by the processing device(s) 202 of the interferometer or other device(s). In other embodiments, at least some of the functions shown in or described with respect to FIGS. 1 through 7 can be implemented or supported using dedicated hardware components. In general, the functions shown in or described with respect to FIGS. 1 through 7 can be performed using any suitable hardware or any suitable combination of hardware and software/firmware instructions. Also, the functions shown in or described with respect to FIGS. 1 through 7 can be performed by a single device or by multiple devices.

The following describes example embodiments of this disclosure that implement or relate to self-calibrating phase interferometry using random forest regression, a neural network, or other machine learning model. However, other embodiments may be used in accordance with the teachings of this disclosure.

In a first embodiment, an apparatus includes multiple antennas each configured to receive one or more incoming signals. The apparatus also includes at least one processing device configured to receive antenna measurements associated with the one or more incoming signals, where the antenna measurements include phase measurements associated with the one or more incoming signals. The at least one processing device is also configured to process the antenna measurements using a trained machine learning model to generate a prediction of an angle of arrival associated with the one or more incoming signals. The trained machine learning model is trained to generate the prediction of the angle of arrival even while compensating for phase errors affecting the antenna measurements.

In a second embodiment, a method includes receiving one or more incoming signals at multiple antennas and providing antenna measurements associated with the one or more incoming signals to a trained machine learning model, where the antenna measurements include phase measurements associated with the one or more incoming signals. The method also includes processing the antenna measurements using the trained machine learning model to generate a prediction of an angle of arrival associated with the one or more incoming signals. The trained machine learning model is trained to generate the prediction of the angle of arrival even while compensating for phase errors affecting the antenna measurements.

In a third embodiment, a non-transitory machine-readable medium contains instructions that when executed cause at least one processor to obtain antenna measurements associated with one or more incoming signals received at multiple antennas, where the antenna measurements include phase measurements associated with the one or more incoming signals. The non-transitory machine-readable medium also contains instructions that when executed cause the at least one processor to provide the antenna measurements to a trained machine learning model and process the antenna measurements using the trained machine learning model to generate a prediction of an angle of arrival associated with the one or more incoming signals. The trained machine learning model is trained to generate the prediction of the angle of arrival even while compensating for phase errors affecting the antenna measurements.

Any single one or any suitable combination of the following features may be used with the first, second, or third embodiment. The trained machine learning model may be configured to implement one or more mappings between different antenna measurements and different angles of arrival. The trained machine learning model may include one of: a random forest regressor and a neural network. The phase measurements may be based on antenna responses of the multiple antennas, and each of the antennas may have a different antenna response than one or more others of the antennas. The trained machine learning model may be trained by providing training data to a machine learning model, comparing outputs of the machine learning model to ground truths, and adjusting the machine learning model based on the comparison. At least some of the training data may include data modified using random phase errors. The antennas may have arbitrary positions on a platform. Predictions of the angle of arrival associated with the one or more incoming signals may be repeatedly identified in real-time.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
multiple antennas each configured to receive one or more incoming signals; and
at least one processing device configured to:
receive antenna measurements associated with the one or more incoming signals, the antenna measurements comprising phase measurements associated with the one or more incoming signals; and
process the antenna measurements using a trained machine learning model to generate a prediction of an angle of arrival associated with the one or more incoming signals;
wherein the trained machine learning model is trained to generate the prediction of the angle of arrival even while compensating for phase errors affecting the antenna measurements.

2. The apparatus of claim 1, wherein the trained machine learning model is configured to implement one or more mappings between different antenna measurements and different angles of arrival.

3. The apparatus of claim 1, wherein the trained machine learning model comprises one of: a random forest regressor and a neural network.

4. The apparatus of claim 1, wherein the phase measurements are based on antenna responses of the multiple antennas, each of the antennas having a different antenna response than one or more others of the antennas.

5. The apparatus of claim 1, wherein the trained machine learning model is trained by providing training data to a machine learning model, comparing outputs of the machine learning model to ground truths, and adjusting the machine learning model based on the comparison, at least some of the training data including data modified using random phase errors.

6. The apparatus of claim 1, wherein the antennas have arbitrary positions on a platform.

7. The apparatus of claim 1, wherein the at least one processing device is configured to repeatedly identify predictions of the angle of arrival associated with the one or more incoming signals in real-time.

8. A method comprising:
receiving one or more incoming signals at multiple antennas;
providing antenna measurements associated with the one or more incoming signals to a trained machine learning model, the antenna measurements comprising phase measurements associated with the one or more incoming signals; and
processing the antenna measurements using the trained machine learning model to generate a prediction of an angle of arrival associated with the one or more incoming signals;
wherein the trained machine learning model is trained to generate the prediction of the angle of arrival even while compensating for phase errors affecting the antenna measurements.

9. The method of claim 8, wherein the trained machine learning model implements one or more mappings between different antenna measurements and different angles of arrival.

10. The method of claim 8, wherein the trained machine learning model comprises one of: a random forest regressor and a neural network.

11. The method of claim 8, wherein the phase measurements are based on antenna responses of the multiple antennas, each of the antennas having a different antenna response than one or more others of the antennas.

12. The method of claim 8, wherein the trained machine learning model is trained by providing training data to a machine learning model, comparing outputs of the machine learning model to ground truths, and adjusting the machine learning model based on the comparison, at least some of the training data including data modified using random phase errors.

13. The method of claim 8, wherein the antennas have arbitrary positions on a platform.

14. The method of claim 8, further comprising:
repeatedly identifying predictions of the angle of arrival associated with the one or more incoming signals in real-time.

15. A non-transitory machine-readable medium containing instructions that when executed cause at least one processor to:
obtain antenna measurements associated with one or more incoming signals received at multiple antennas, the antenna measurements comprising phase measurements associated with the one or more incoming signals;
provide the antenna measurements to a trained machine learning model; and
process the antenna measurements using the trained machine learning model to generate a prediction of an angle of arrival associated with the one or more incoming signals;
wherein the trained machine learning model is trained to generate the prediction of the angle of arrival even while compensating for phase errors affecting the antenna measurements.

16. The non-transitory machine-readable medium of claim 15, wherein the trained machine learning model is configured to implement one or more mappings between different antenna measurements and different angles of arrival.

17. The non-transitory machine-readable medium of claim 15, wherein the trained machine learning model comprises one of: a random forest regressor and a neural network.

18. The non-transitory machine-readable medium of claim 15, wherein the phase measurements are based on antenna responses of the multiple antennas, each of the antennas having a different antenna response than one or more others of the antennas.

19. The non-transitory machine-readable medium of claim 15, wherein the trained machine learning model is trained by providing training data to a machine learning model, comparing outputs of the machine learning model to ground truths, and adjusting the machine learning model based on the comparison, at least some of the training data including data modified using random phase errors.

20. The non-transitory machine-readable medium of claim 15, further containing instructions that when executed cause the at least one processor to repeatedly identify predictions of the angle of arrival associated with the one or more incoming signals in real-time.
